(19) United States
(12) Patent Application Publication
(10) Pub. No.: US 2015/0097148 A1
(43) Pub. Date: Apr. 9, 2015

(54) WINCH DRUM

(71) Applicant: Trinity Industries, Inc., Dallas, TX (US)

(72) Inventor: Emrey Zachariah Wiley, Gallatin, TN (US)

(21) Appl. No.: 14/569,345

(22) Filed: Dec. 12, 2014

Related U.S. Application Data
(63) Continuation-in-part of application No. 13/665,612, filed on Nov. 5, 2012.

(51) Int. Cl. B66D 1/34; B66D 1/30

(52) U.S. Cl. CPC B66D 1/34; B66D 1/30
USPC 254/266

(57) ABSTRACT

According to some embodiments, a winch apparatus comprises a winch housing and a winch drum rotationally mounted to the housing. The winch drum is configured to rotate around its central axis. The winch drum comprises a slotted keyhole for coupling a winch line to the winch drum. The slotted keyhole comprises an opening at a first end configured to receive the winch line positioned in the slotted keyhole and an opening at a second end configured to retain the winch line. A longitudinal axis of the slotted keyhole is offset from the direction the winch line pays onto the winch drum.

### RELATED APPLICATION

This application is a continuation-in-part of U.S. patent application Ser. No. 13/665,612, entitled “HORIZONTAL DRUM WINCH,” Attorney's Docket 091078.1704 filed Oct. 31, 2012.

### TECHNICAL FIELD OF THE INVENTION

This disclosure generally relates to marine winches, and more particularly to a winch drum.

### BACKGROUND

Winches for tensioning and paying out wire line or rope are well known in the marine industry. Deck hands use manual or powered winches to assist with tasks such a loading or unloading cargo or connecting two vessels together. Marine vessels may also maintain their position in relation to a mooring structure such as a dock by using winches.

The barge transportation industry uses winches to connect barges to each other in a barge tow and to connect the barge tow to a tow vessel. Each barge typically has two or four deck-mounted, manually-operated winches. A deck hand connects the winch line to a deck fitting on an adjacent barge and then ratchets the line tight, connecting the barges together. To disassemble the barge tow, the deck hand releases tension on the winch and pays out the line. A tow vessel typically connects to the rear of the barge tow in a similar manner. During transportation, deck hands may need to disassemble and reassemble the barge tow to pass through locks or navigate constricted waterways. Deck mounted winches may also secure a barge to a dock during loading or unloading operations.

### SUMMARY OF THE INVENTION

In accordance with particular embodiments of the present disclosure, a winch apparatus comprises a winch housing and a winch drum rotationally mounted to the housing. The winch drum is configured to rotate around its vertical axis. The winch drum comprises a slotted keyhole for coupling a winch line to the winch drum. The slotted keyhole comprises an opening at a first end configured to receive the winch line positioned in the slotted keyhole and an opening at a second end configured to retain the winch line. A longitudinal axis of the slotted keyhole is offset from horizontal.

The winch apparatus may comprise a drive mechanism coupled to the winch drum for rotating the winch drum. The drive mechanism may include a ring coupled to the winch drum with one or more protrusions providing grip for rotating the drive mechanism.

In accordance with particular embodiments, a method for using a winch apparatus includes coupling a winch line to a slotted keyhole of a winch drum rotationally mounted to a winch housing. A longitudinal axis of the slotted keyhole is offset from horizontal. The slotted keyhole comprises an opening at a first end of the slotted keyhole configured to receive the winch line positioned in the slotted keyhole and an opening at a second end of the slotted keyhole configured to retain the winch line positioned in the slotted keyhole.

Certain embodiments may provide one or more technical advantages. In some embodiments, the horizontal configuration of a winch apparatus provides efficient use of deck space and a low profile design less inclined to interfere with operations on deck. Winch line may be stored within the winch housing providing further conservation of deck space and increased longevity of the winch line. Storing the winch line horizontally around the winch drum allows for simple transitioning from a stowed condition to a tensioned condition. The slotted keyhole provides a time savings when securing winch line to the winch drum. In particular embodiments, the strength of the winch line terminating fixture in combination with the slotted keyhole facilitates securing the winch line to the winch drum without maintaining a minimum number of wraps of winch line on the winch drum. This is advantageous because requiring a minimum number of wraps decreases the usable length of the winch line.

In particular embodiments, a longitudinal axis of the slotted keyhole is offset from a direction perpendicular to the central axis of the winch drum. When the winch line is under tension, the offset of the slotted keyhole causes a force to be applied to the winch line causing the winch line to climb toward the winch line termination at the slotted keyhole and neatly spool around the winch drum. In particular embodiments, the circumference of the winch drum tapers towards the end of the winch drum comprising the slotted keyhole. The taper also facilitates the winch line to climb up the winch drum and neatly spool around the winch drum when the winch line is under tension. When the winch line neatly spools around the winch drum, fouling of the winch line is reduced, which increases lifespan and performance of the winch line and reduces time spent by deck hands untangling fouled winch line. Additionally, releasing tension on a winch line under tension is safer when the winch line is neatly spooled around the winch drum.

In additional embodiments, the low profile ring coupled to the winch drum minimizes interference with deck operations, which is a common problem with traditional winch designs. Deck hands operate a winch to assemble and disassemble a barge tow many times during a voyage. Any efficiencies in winch design result in cost savings for the barge operator.

In particular embodiments, the winch drum may be mounted vertically instead of horizontally. For example, the winch drum may be rotationally mounted to a vertical housing and configured to rotate around its horizontal axis. In such embodiments, a line guide may guide the wire line onto the winch drum at a portion of the winch drum farther away from the slotted keyhole. In this manner the line guide may provide similar functionality for the vertical winch drum configuration that gravity provides for the horizontal winch drum configuration. A vertically mounted winch drum may provide some or all of the advantages described above with respect to a horizontally mounted winch drum.

As a result, particular embodiments of the present disclosure may provide numerous technical advantages. Particular embodiments the present disclosure may provide some, none, all, or additional technical advantages.

### BRIEF DESCRIPTION OF THE DRAWINGS

A more complete and thorough understanding of the particular embodiments and advantages thereof may be acquired by referring to the following description taken in conjunction with the accompanying drawings, in which like reference numbers indicate like features, and wherein:

FIG. 1A is an overhead view of an example barge tow where the barges are connected to each other and a tug vessel by multiple winches and winch line;

FIG. 1B is a perspective view of the deck of one of the barges in FIG. 1A;

FIGS. 2A-2C illustrate a perspective and two side schematics of a winch assembly, in accordance with particular embodiments;

FIGS. 3A and 3B illustrate a perspective and side schematic of a winch drum assembly, in accordance with particular embodiments;

FIG. 4A illustrates a winch assembly with a winch line under tension, in accordance with particular embodiments;

FIG. 4B illustrates a winch assembly with a winch line stored in the housing, in accordance with particular embodiments;

FIG. 5 further illustrates interaction between a winch line and a slotted keyhole of a winch drum, in accordance with particular embodiments; and

FIGS. 6A and 6B illustrate a side perspective and front schematic of a winch assembly, in accordance with particular embodiments.

### DETAILED DESCRIPTION

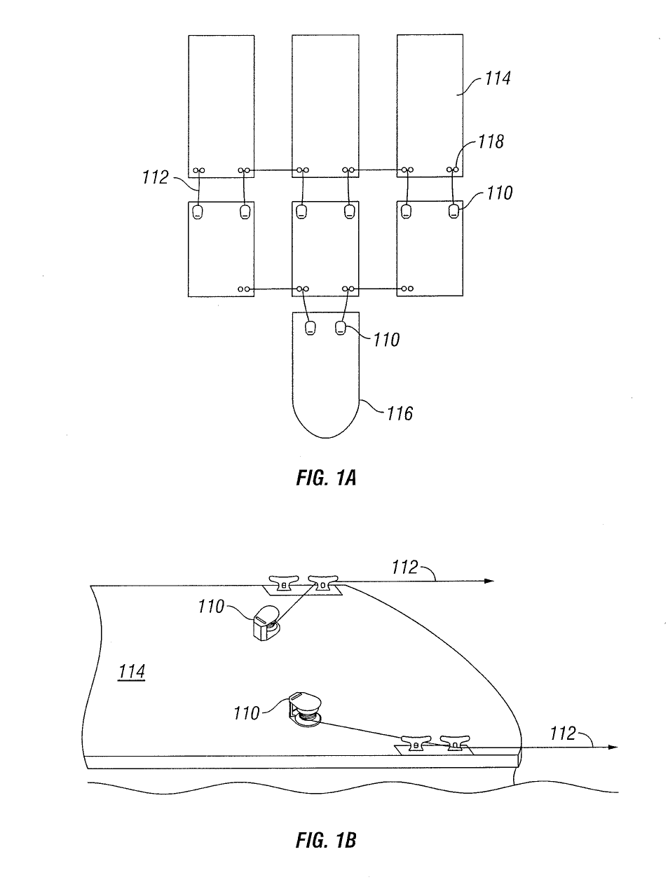

Particular embodiments of the invention and its advantages are best understood by reference to FIGS. 1 through 6B wherein like reference numbers indicate like features.

A goal of the barge transportation industry is to maximize the usage of available barge deck space. Existing vertically mounted winches do not efficiently optimize the use of deck space. Vertically mounted winches protrude above the highest point on the barge (e.g., the barge coaming) where they may become obstacles during typical operation and use, including the loading or unloading of cargo. Typically, large hand wheels and ratchets with long extensions operate the winch drive mechanism. These devices further consume deck space and are obstacles during normal deck operations.

In addition to physically consuming more space, vertically mounted winch assemblies waste deck space by not efficiently storing slack winch line. A typical vertically mounted winch assembly has a winch drum approximately ten inches in diameter wound with one inch wire rope. The stiffness of one inch wire rope will cause it to unwind from a 10 inch diameter winch drum when the wire rope is not under tension. Unwinding of the wire rope can lead to fouling. To prevent fouling, deck hands store the slack wire rope on the deck, which consumes additional deck space.

Minimizing the length of wire rope required for operation also leads to increased efficiencies. Conventional winches typically require a minimum number of wraps around the winch drum, referred to as deadwraps, to keep the wire rope secured during operation. The extra wraps increase the length of the wire rope and/or decrease the length of usable wire rope. The extra wraps also increase the time for a deck hand to secure or unsecure the winch line from the winch drum.

FIG. 1A illustrates an overhead view of an example barge tow where barges are connected to each other and a tug vessel by multiple winches and winch line. One or more winches 110 are mounted to the deck of barge 114. Winch line 112 couples winch 110 mounted on barge 114 to mounting point 118 on adjacent barge 114. A deck hand secures barges 114 together by tensioning winch line 112 with winch 110. A deck hand separates barges 114 by releasing tension on winch line 112. Winch line 112 may comprise wire rope, nylon rope, cotton rope, a synthetic strap, chain, or any coupling material with the appropriate tensile strength for a particular embodiment.

One or more winches 110 may also be mounted to the deck of tug vessel 116. Winch line 112 couples winch 110 mounted on tug vessel 116 to mounting point 118 on adjacent barge 114. A deck hand secures tug vessel 116 to adjacent barge 114 by tensioning winch line 112 with winch 110. A deck hand separates tug vessel 116 from adjacent barge 114 by releasing tension on winch line 112. In another embodiment, mounting point 118 may be located on tug vessel 116, and winch 110 may be located on barge 114. Tug vessel 116 tows the collection of barges 114 from a source along a waterway to a destination.

FIG. 1B illustrates a perspective view of the deck of the barge in FIG. 1A. This figure shows the horizontal orientation of winch 110 and winch line 112. In other embodiments barge 114 may have winches 110 mounted at any number of locations. In particular embodiments, winches 110 may generally be located near a corner of barge 114 and close to the fittings used to secure barges 114.

In addition to coupling barge 114 to adjacent barge 114 or tug vessel 116 to adjacent barge 114, winch 110 and winch line 112 may also couple marine vessels to a mooring structure such as a dock. Winch 110 may be mounted either on the dock, the marine vessel, or both. One of skill in the art would contemplate mounting winch 110 on any essentially suitable surface, such as a generally horizontal surface.

Barge 114 may be a simple structure without onboard power. In that environment manual operation of winch 110 is desirable. In other environments where power is available, such as tug vessel 116 or the dock of a commercial shipyard, a motor operated winch 110 may be desirable. One of skill in the art would understand how to adapt a motor to operate winch 110.

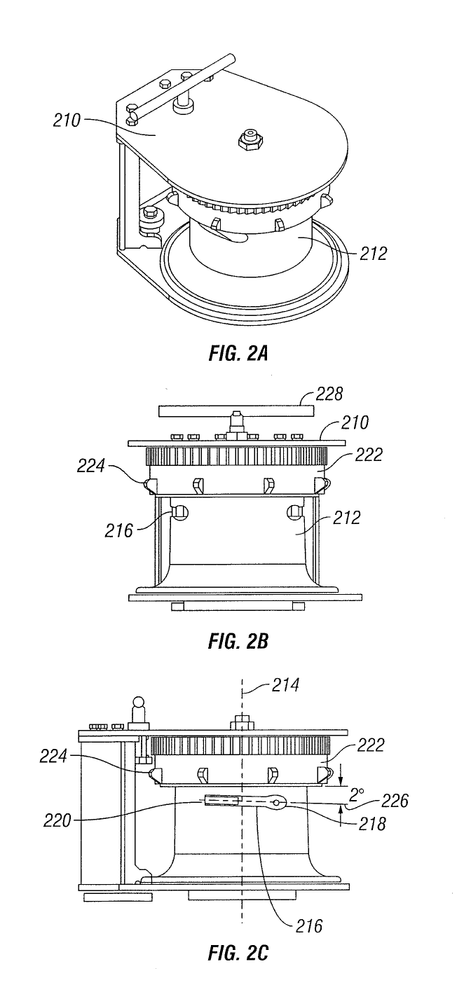

FIGS. 2A-2C illustrate perspective and side schematics of a winch housing and a winch drum, in accordance with particular embodiments. Winch drum 212 is rotationally mounted to winch housing 210. Winch drum 212 rotates around vertical axis 214. In particular embodiments, the surface of winch drum 212 that holds wraps of winch line 112 comprises a generally smooth surface. Winch drum 212 contains at least one winch line fastener, such as slotted keyhole 216. Slotted keyhole 216 comprises first end 218 configured to receive winch line 112 and second end 220 configured to retain winch line 112.

One benefit of slotted keyhole 216 is that it secures winch line 112 to winch drum 212 without additional wraps of winch line 112 around winch drum 212. The end of winch line 112 slides into first end 218 of slotted keyhole 216. Tension on winch line 112 pulls the end of winch line 112 towards second end 220 of slotted keyhole 216. Second end 220 is configured to prevent winch line 112 from sliding through or out of slotted keyhole 216. Thus slotted keyhole 216 secures winch line 112 to winch drum 212 without the aid of additional friction provided by extra wraps of winch line 112 around winch drum 212.

Another benefit is that a deck hand can quickly insert or remove winch line 112 from slotted keyhole 216. With a conventional winch, a deck hand may have to attach a winch line to the winch drum with a conventional fastening device, such as a U-bolt, and then wrap the winch line around the winch drum several times. The deck hand may have to use a wrench or ratchet tool to secure the U-bolt. The deck hand may first have to retrieve the tool from a tool storage location, which, because of the remoteness of the barge or the size of the barge tow, may be time consuming. The deck hand may reverse the steps to remove the winch line. Slotted keyhole 216 facilitates a deck hand to quickly secure winch line 110 by inserting the end of winch line 112 into first end 218. A deck hand removes winch line 112 from slotted keyhole 216 by releasing tension on winch line 110 and reversing winch line 110 back out of first end 218. Other embodiments may use slots of different shapes to secure winch line 112 to winch drum 212.

Slotted keyhole 216 includes a longitudinal axis 226 that is generally oriented in the same direction that winch line 112 pays out from winch drum 212 (e.g., a direction perpendicular to the central axis of the winch drum, such as a direction perpendicular to vertical axis 214). Longitudinal axis 226 is slightly offset from horizontal (i.e. slightly offset from a line perpendicular to the central axis of the winch drum). In one embodiment, longitudinal axis 226 is offset at least approximately two degrees from horizontal. The offset facilitates winch line 112 to neatly spool around winch drum 212 when winch line 112 is under tension. Without the offset, winch line 112 may tend to overlap itself around winch drum 212, which can lead to tangling, fouling, and increased wear on winch line 112. Other embodiments, such as embodiments that comprise, for example, different winch lines, and/or different winch line fasteners, may vary the offset angle accordingly.

A geared drive mechanism (not illustrated) coupled to winch drum 212 rotates winch drum 212. The drive mechanism may be located within winch drum 212, on the surface of winch drum 212, or any location suitable for applying rotational force to the winch drum. In particular embodiments, the geared drive mechanism may include a single or multiple stage gear reduction to increase the mechanical advantage at its input. Conventional winches use a large hand wheel or bar shaped handle to turn the drive mechanism. These methods for turning the drive mechanism take up space on deck and present obstacles to efficient deck operations. In one embodiment ring 222 is coupled to the geared drive mechanism. Ring 222 has a plurality of protrusions 224 allowing a deck hand to grip ring 222 while applying rotational force. Rotation of ring 222 causes rotation of winch drum 212. The particular size and configuration of gears coupling ring 222, the drive mechanism, and winch drum 212 will determine the amount of force required to rotate winch drum 212. The low profile design of ring 222 and protrusions 224 will minimize interference with deck operations.

Other embodiments contemplate ring 222 functioning as the primary tensioning mechanism in conjunction with secondary tensioning mechanism 228. Secondary tensioning mechanism 228 is also coupled to the geared drive mechanism to provide additional tensioning. For example, ring 222 may be coupled through gears that allow easy rotation of winch drum 212 and relatively quick tensioning of winch line 112. Secondary tensioning mechanism 228 may be coupled through gears of a different size that allow for higher tensioning but requires more turns.

A horizontally mounted winch assembly provides a more compact and more efficient winch design. Horizontally mounted winch 110 maintains a low profile by not protruding as high above the deck surface of barge 114. Low profile winch 110 is less of an obstacle to deck operations. Another benefit is that a horizontally mounted winch assembly can contain a larger diameter winch drum 212 in approximately the same footprint as a conventional vertically mounted winch assembly. The larger diameter winch drum 212 allows for storage of slack winch line 112 within winch housing 210 without tangling. Additionally, horizontal storage of winch line 112 around winch drum 212 allows for simple transition from a stowed condition to a tensioned condition of winch line 112. Finally, slotted keyhole 216 for retaining winch line 112 in winch drum 212 requires fewer wraps of winch line 112, allowing for shorter lengths of winch line 112. Slotted keyhole 216 also facilitates a deck hand quickly securing or unsecuring winch line 110.

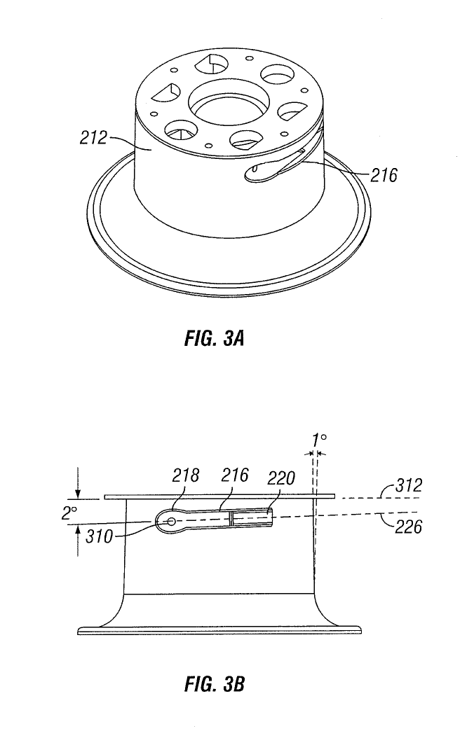

FIGS. 3A and 3B illustrate a perspective and side schematic of a winch drum assembly, in accordance with particular embodiments. The figures highlight the orientation of longitudinal axis 226 of slotted keyhole 216 in relation to horizontal axis 312. Additionally, FIG. 3B highlights opening 310 located in first end 218 of slotted keyhole 216. In one embodiment, opening 310 accepts a fastener configured to retain winch line 112 in slotted keyhole 216 when winch line 112 is not under tension. Tension on winch line 112 holds the end of winch line 112 tight against second end 220 of slotted keyhole 216. When winch line 112 is not under tension, the end of winch line 112 may easily be removed through first end 218. The benefits of efficiently removing winch line 112 from winch drum 212 were discussed above. In other embodiments, a deck hand may find it beneficial for winch line 112 to remain secured to winch drum 212 even when winch line 112 is not under tension. In those embodiments, a deck hand may insert a removable fastener into opening 310 after winch line 112 is secured to winch drum 212. The removable fastener prevents winch line 112 from sliding back through first end 218 even without tension on winch line 112. The deck hand then removes the fastener before unsecuring winch line 112 from winch drum 212. For example, opening 310 could be threaded to accept a socket head cap screw. In other embodiments, opening 310 is configured to accept any removable fastener operable to retain winch line 112 within slotted keyhole 216.

Also illustrated in FIG. 3B is the tapered circumference of winch drum 212, according to particular embodiments. In particular embodiments, winch drum 212 is wider in circumference at its bottom portion than its top portion. In particular embodiments, winch drum 212 tapers approximately one degree from its bottom portion to its top portion. Other embodiments may vary the degree of taper accordingly. A particular advantage of the taper is to prevent fouling of winch line 112. For example, winch drum 212 tapers in towards its top portion where slotted keyhole 216 is located. When winch line 112 is under tension, the taper of winch drum 212 facilitates winch line 112 climbing up winch drum 212 and neatly spooling around winch drum 212.

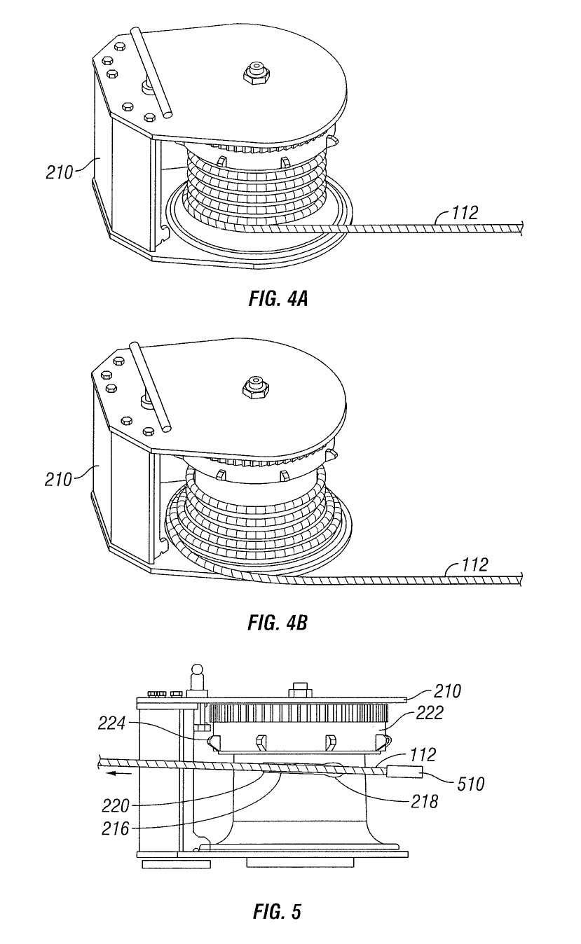

FIG. 4A illustrates a winch assembly with a winch line under tension, in accordance with particular embodiments. Winch line 112 is neatly wrapped around winch drum 212 when winch line 112 is under tension.

FIG. 4B illustrates a winch assembly with a winch line stored within the winch housing when the winch line is not under tension, in accordance with particular embodiments. Because of its horizontal configuration, winch drum 212 may have a larger diameter (e.g., a diameter of approximately eighteen inches) without interfering with deck operations. The larger diameter allows winch line 112 to remain coiled within winch housing 210 when not under tension. Storing winch line 112 within winch housing 210 keeps winch line 112 off the deck of barge 114 and out of the way of deck operations. This improves the longevity of winch line 112.

In operation, as tension is applied to winch line 112, winch line 112 transitions from its loosely coiled storage position by climbing the smooth surface of winch drum 212 until winch line 112 is tightly and neatly wrapped around winch drum 212.

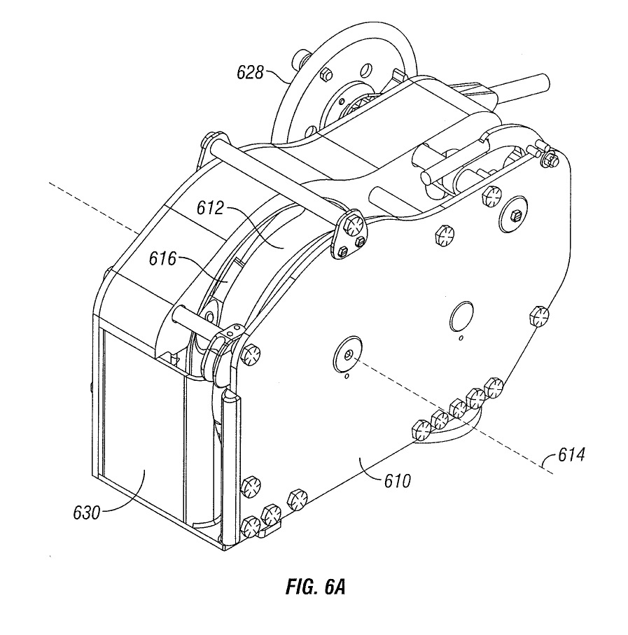

FIG. 5 further illustrates the interaction of a winch line and a slotted keyhole of winch drum, in accordance with particular embodiments. In one embodiment, winch line 112 is terminated with fixture 510. First end 218 of slotted keyhole 216 is configured to be large enough to accept winch line 112 and fixture 510. Second end 220 of slotted keyhole 216 is configured so winch line 112 may pass through but fixture 510 may not. In some embodiments, fixture 510 may be a swaged button. In particular embodiments, the shape of line terminating fixture may vary in accordance with the shape of the slot in winch drum 212. For example, one of skill in the art might consider using a T-shaped line terminating fixture with a T-shaped slot in winch drum 212.

In the illustrated embodiments, winch line 112 is terminated with a swaged button and slotted keyhole 216 may be referred to as button socket 216. In particular embodiments, other configurations of slotted keyhole 216 may also be referred to as button socket 216.

In particular embodiments, a winch line fastener may comprise a slotted keyhole, such as a button socket, or any other suitable method for coupling a winch line to a winch drum. Some such methods may include a keyhole and others may not. In some embodiments, winch line 112 may be coupled to winch drum 212 with a winch line fastener mounted to the surface of winch drum 212. For example, a U-bolt may clamp winch line 112 to winch drum 212. Because winch line 112 may be stored within winch housing 110, in some embodiments, winch line 112 may be permanently coupled (e.g., welded) to winch drum 212.

In particular embodiments, such as those illustrated, a longitudinal axis of the winch line fastener may be offset from a line perpendicular to the central axis of the winch drum. In other embodiments, a winch line fastener may couple winch line 112 to winch drum 212 in any suitable configuration. In such embodiments, winch line fastener may comprise additional elements, such as a tab or guide, that orient the winch line such that the winch line pays onto the winch drum at an angle offset from a line perpendicular to the central axis of the winch drum. As a particular example, winch line 112 may be coupled to winch drum 212 by a winch line fastener such that winch line 112 is fastened perpendicular to the central axis of winch drum 212. In this example, a metal tab may protrude from winch drum 212 in front of the portion of the winch line fastener that couples winch line 112 to winch drum 212, and the metal tab may be configured to orient winch line 112 such that winch line 112 pays onto winch drum 212 at a two degree angle offset from a line perpendicular to the central axis of the winch drum. In particular embodiments, winch line 112 may be coupled to winch drum 212 by any suitable winch line fastener, or combination of winch line fastening and orienting elements, such that winch line 112 pays onto winch drum 212 at an angle offset from a line perpendicular to the central axis of the winch drum.

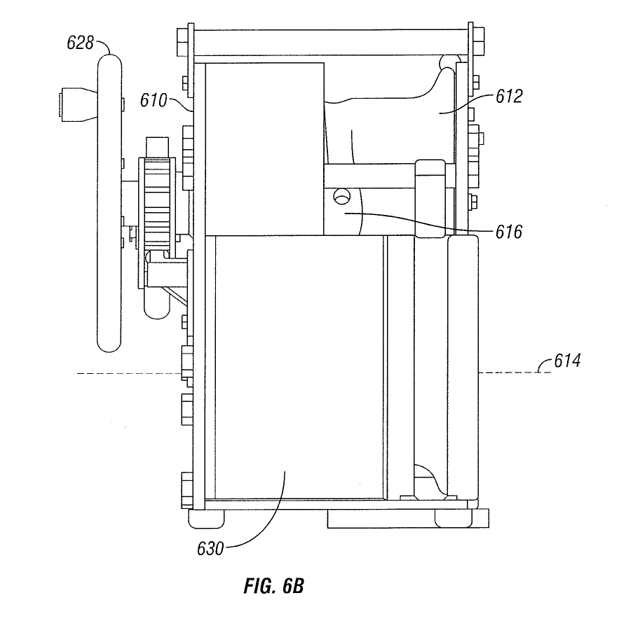

FIGS. 6A and 6B illustrate a side perspective and front schematic of a winch assembly, in accordance with particular embodiments. The illustrated winch components are similar to those illustrated in FIGS. 2-5, except that winch drum 612 is mounted in vertical winch housing 610 such that winch drum 612 rotates around horizontal axis 614. Winch drum 612 includes at least one slotted keyhole 616 configured to receive and retain winch line 112.

In the illustrated embodiment, slotted keyhole 616 is located near the left portion of winch drum 612. Slotted keyhole 616 includes a longitudinal axis that is generally oriented in the same direction that winch line 112 pays out from winch drum 612 (e.g., a direction perpendicular to the central axis of the winch drum, such as a direction perpendicular to horizontal axis 614). The longitudinal axis is slightly offset from vertical (i.e. slightly offset from a line perpendicular to the central axis of the winch drum). In one embodiment, the longitudinal axis is offset at least approximately two degrees from vertical. When winch line 112 is under tension the offset from vertical of slotted keyhole 616 exerts a force on winch line 112 which facilitates winch line 112 moving from right to left and neatly spooling around winch drum 212. Other embodiments may vary the offset angle accordingly. Other embodiments may locate slotted keyhole 616 near the right portion of winch drum 612 and the offset of slotted keyhole 616 may cause winch line 112 to move from left to right when winch line 112 is under tension.

In particular embodiments, the circumference of winch drum 612 is slightly tapered such that one side of winch drum 612 is slightly wider than the opposite side of winch drum 612. In the illustrated embodiment, the circumference of winch drum 612 is wider on the right portion and tapers in towards the left portion where slotted keyhole 616 is located. In particular embodiments, the circumference of winch drum 612 tapers approximately one degree from its right portion to its left portion. Other embodiments may vary the taper accordingly. A particular advantage is that winch line 112 moves from right to left and neatly spools around winch drum 612 as tension is applied to winch line 112.

In particular horizontal embodiments illustrated above, gravity facilitates the spooling of the winch line on the winch drum at the bottom portion of the winch drum, which is the portion of the winch drum further from the slotted keyhole. In particular embodiments, the offset angle of the slotted keyhole and/or the taper of the winch drum facilitate the winch line climbing the winch drum as tension is applied to the winch line. In the vertical embodiment illustrated in FIGS. 6A and 6B, line guide 630 guides winch line 110 on winch drum 612. In the illustrated embodiment, slotted keyhole 616 is positioned on a left portion of winch drum 612 and line guide 630 guides winch line 110 on a right portion of winch drum 612. In other embodiments, the orientation of winch drum 612 and line guide 630 may be reversed such that winch line 110 spools from left to right. Line guide 630 may provide similar functionality for the vertical winch drum configuration that gravity provides for the horizontal winch drum configuration.

Although the illustrated embodiments depict the winch drum rotating around a horizontal or vertical axis, in other embodiments the winch drum may rotate around an axis offset from horizontal or vertical. For example, in particular embodiments the winch drum may rotate around an axis slightly offset from horizontal or slightly offset from vertical. In such embodiments, the offset of the winch drum's central axis may facilitate the winch line neatly spooling around the winch drum.

Although embodiments of the present disclosure and their advantages have been described in detail, it should be understood that various changes, substitutions and alternations can be made herein without departing from the spirit and scope of the invention as defined by the following claims.

1-20. (canceled)

21. A winch apparatus, comprising:
a winch housing;
a winch drum rotationally mounted to the housing and configured to rotate around a central axis of the winch drum; and
a winch line fastener for coupling a winch line to the winch drum, wherein the winch line fastener is oriented such that the winch line pays onto the winch drum at an angle offset from a line perpendicular to the central axis of the winch drum.

22. The winch apparatus of claim 21, wherein the winch line fastener is oriented such that the winch line pays onto the winch drum at an angle at least approximately two degrees offset from the line perpendicular to the central axis of the winch drum.

23. The winch apparatus of claim 21, wherein:
a circumference of the winch drum is tapered from a first edge to a second edge, the second edge opposite from the first edge; and
the circumference of the second edge is greater than the circumference of the first edge.

24. The winch apparatus of claim 23, wherein:
the winch line fastener is positioned near the first edge of the winch drum; and
the winch line pays onto the winch drum near the second edge of the winch drum.

25. The winch apparatus of claim 23, wherein the winch drum is tapered approximately one degree from the first edge to the second edge.

26. The winch apparatus of claim 23, further comprising:
a line guide coupled to the winch housing and positioned to guide the winch line onto the winch drum near the second edge of the winch drum.

27. The winch apparatus of claim 21, wherein the winch line fastener is recessed into the winch drum.

28. The winch apparatus of claim 21, wherein the winch line fastener comprises a slotted keyhole comprising:
an opening at a first end of the slotted keyhole configured to receive the winch line positioned in the slotted keyhole; and
an opening at a second end of the slotted keyhole configured to retain the winch line positioned in the slotted keyhole; and
wherein a longitudinal axis of the slotted keyhole is offset from a line perpendicular to the central axis of the winch drum.

29. The winch apparatus of claim 28, wherein the first end of the slotted keyhole is oriented at least approximately two degrees offset from the line perpendicular to the central axis of the winch drum.

30. The winch apparatus of claim 28, where the first end of the slotted keyhole accepts a removable fastener configured to retain the winch line in the slotted keyhole when the winch line is not under tension.

31. The winch apparatus of claim 28, wherein the slotted keyhole comprises a button socket.

32. A method, comprising:
coupling a winch line to a winch drum with a winch line fastener, the winch drum rotationally mounted to a winch housing, wherein the winch line fastener is oriented such that the winch line pays onto the winch drum at an angle offset from a line perpendicular to the central axis of the winch drum; and
rotating the winch drum in a first direction around the central axis of the winch drum to tension the winch line.

33. The method of claim 32, wherein the winch line fastener is oriented such that the winch line pays onto the winch drum at an angle at least approximately two degrees offset from the line perpendicular to the central axis of the winch drum.

34. The method of claim 32, wherein:
a circumference of the winch drum is tapered from a first edge to a second edge, the second edge opposite from the first edge; and
the circumference of the second edge is greater than the circumference of the first edge.

35. The method of claim 34, wherein a line guide is coupled to the winch housing and is positioned to guide the winch line onto the winch drum near the second edge of the winch drum.

36. A winch apparatus, comprising:
a winch housing;
a winch drum rotationally mounted to the housing and configured to rotate around a central axis of the winch drum; and
a winch line fastener configured to couple a winch line to the winch drum; wherein:
a circumference of the winch drum is tapered from a first edge to a second edge, the second edge opposite from the first edge; and
the circumference of the second edge is greater than the circumference of the first edge.

37. The winch apparatus of claim 36, wherein the winch drum is tapered approximately one degree from the first edge to the second edge.

38. The winch apparatus of claim 36, wherein the winch line is coupled to the winch drum such that a longitudinal axis of the winch line is offset from a line perpendicular to the central axis of the winch drum.

39. The winch apparatus of claim 38, wherein the longitudinal axis of the winch line is offset from a line perpendicular to the central axis of the winch drum by at least approximately two degrees.

40. The winch apparatus of claim 36, wherein the winch line fastener is recessed into the winch drum.
